(19) United States
(12) Patent Application Publication
(10) Pub. No.: US 2018/0042711 A1
(43) Pub. Date: Feb. 15, 2018

(54) ELASTOMERIC DEVICES INCLUDING AN IONIC FLUORIDE COMPOUND

(71) Applicant: Ryan Johansen, West Jordan, UT (US)

(72) Inventor: Ryan Johansen, West Jordan, UT (US)

(21) Appl. No.: 15/666,870

(22) Filed: Aug. 2, 2017

Related U.S. Application Data
(60) Provisional application No. 62/372,581, filed on Aug. 9, 2016.

(51) Int. Cl. A61C 19/06

(52) U.S. Cl. CPC A61C 19/063

(57) ABSTRACT

A device and method for treating teeth, the device includes an elastomeric body, the elastomeric body including: an elastomer and an ionic fluoride compound.

### BACKGROUND

For many years tooth decay has been diagnosed and treated using dental surgery to remove the decay and then place an appropriate dental restoration to restore the tooth. This process of tooth restoration costs billions annually worldwide by way of treatment, dental materials, and patient time taken off from work. Until recently, there has been little discussion about treating dental decay medically rather than surgically.

One of the major challenges in the pediatric dental field is treating dental decay in children. Many children have situational anxiety that prohibits them from being treated, requiring sedation and/or general anesthesia to treat dental decay.

Many agents have been developed to treat dental decay medically. These are usually in the form of chemical agents that are applied to teeth via rinses, varnishes, gels, foams, and pastes. There are limitations to these products. The inability to achieve a sustained release and target specific areas reduces their effectiveness.

### BRIEF DESCRIPTION OF THE DRAWINGS

The accompanying drawings illustrate various examples of the principles described herein and are a part of the specification. The illustrated examples are merely illustrative and do not limit the scope of the claims. Like numerals denote like but not necessarily identical elements.

FIGS. 1A and 1B show a top view and a cross sectional view of a device according to the present disclosure.

FIGS. 2A and 2B show a top view arid a cross sectional view of a device according to the present disclosure.

FIGS. 3A and 3B show a top view arid a cross sectional view of a device according to the present disclosure.

FIGS. 4A and 4B show a top view arid a cross sectional view of a device according to the present disclosure.

FIGS. 5A and 5B show a top view and a cross sectional view of a device according to the present disclosure.

FIGS. 6A and 6B show a top view and a cross sectional view of a device according to the present disclosure.

FIGS. 7A and 7B show a top view and a cross sectional view of a device according to the present disclosure.

FIG. 8 shows a flowchart for a process consistent with the present disclosure.

FIG. 9 shows a perspective drawing of two devices, each between two adjacent teeth according to the present disclosure.

Throughout the drawings, identical reference numbers designate similar, but not necessarily identical, elements.

### DETAILED DESCRIPTION

Fluorides may react with calcium in teeth, such as hydroxyapatite, to form a fluoro-apatite chemical bond which may render the teeth more resistant to decay. Much of the hydroxyapatite in enamel and dentin has carbonates in place of the hydroxy groups where exposed to the environment. The hydroxyl group and/or carbonates can be substituted with a fluoride ion to render the teeth less susceptible to decay. Fluorides such as sodium fluoride have seen use in drinking water and toothpastes which increase the resistance of enamel and dentin to acid, especially the acidic bacterial byproducts.

The use of fluoride treatments, especially as pastes and coatings applied to teeth, have also provided some fluorination of the minerals in teeth. However, the application time of such treatments is relatively low and saliva tends to dislodge and break up such coatings. Further, some of the pastes and coating ends up being swallowed. In the stomach, sodium fluoride may react with the hydrochloric stomach acid to produce hydrofluoric acid and sodium chloride. Accordingly, it is desirable to provide ionic fluoride compounds to the teeth in a manner that provides a sustained application to the target dental enamel and dentine while limiting the amount of ingested fluoride.

Many children are diagnosed with inter-proximal caries beginning as early as 2 years old. These caries are seen visually and/or radiographically. Radiographically, inter-proximal radiolucencies can be visualized and characterized as incipient, or thru the dentino-enamel junction. If inter-proximal caries can be seen visually, they are generally advanced lesions.

The disclosed devices treat incipient caries by preventing their further growth and arresting the decay. The devices may be used to treat more advanced carious lesions that have slightly passed the dentino-enamel junction by arresting the active growth of the caries. In some cases, this may delay or prevent the need to restore the tooth. Delaying the treatment could provide value, for example, if the patient is medically compromised and/or exhibits high anesthesia risk where a treatment plan including general anesthesia is very guarded. Similarly, children who are expected to lose the relevant primary teeth in a short period of time may benefit from placement of the elastomeric device.

In some examples, placing the device can be done by using two strands of floss and forcing the rings between the contacts of the teeth so the contacts of the teeth are inside the middle of the ring. The devices may be placed by trained dental assistants or hygienists under the direction of a dentist. Ideally, this procedure of placing the rings would be registered with a Code on Dental Procedures and Nomenclature (CDT) and billed to insurance.

As used in this specification and the associated claims, the term ionic fluoride compound should be understood broadly as a class of chemicals that have the ability in solution to provide a fluoride ion for a chemical reaction. The fluoride may be provided complexed with one or more other charged species. Complete dissociation of the fluoride from the other parts of the ionic fluoride compound is not required. Sodium fluoride and silver diamine fluoride are both examples of ionic fluoride compounds that provide fluoride ions available for reaction.

The present specification describes an oral implant made of an elastomer and an ionic fluoride compound. The implant may be placed between two teeth. For example, the implant may be placed where interproximal caries are present. The implant may be applied between two healthy teeth to strengthen the enamel. The implant may be used in patients that exhibit a higher risk for tooth decay. The implant provides a source of stabilized fluoride ions to react with the target site.

In one example, the target site is isolated by the oral implant, allowing a relatively high localized concentration of fluoride without disturbing the general balance of the saliva and mouth. In some cases, just an inner surface of the elastomeric implant is designed to elute the ionic fluoride compound while the outer surface has a lower elution rate.

The elastomeric oral implant may be placed by stretching the implant. This causes the implant to thin, allowing the implant to slip into place between the teeth. The implant is then relaxed and recovers. The elastic properties of the implant cause the implant to push against the two surfaces of the teeth on either side, holding the implant in place. The implant may also induce a slight separation of the teeth. Removal can be accomplished by flossing the implant out a few weeks after placement. The implant then releases from between the teeth and is removed.

Accordingly, the present specification describes a device for treating teeth, the device including an elastomeric ring, the elastomeric ring including: an elastomer and an ionic fluoride compound.

In another example, the present specification describes a device for treating teeth, the device including an elastomeric body, the elastomeric body including: an elastomer and an ionic fluoride compound.

In another example, the present specification describes a method of treating and preventing dental carries in teeth, the method including placing an elastomer between two adjacent teeth, the elastomer including an ionic fluoride compound.

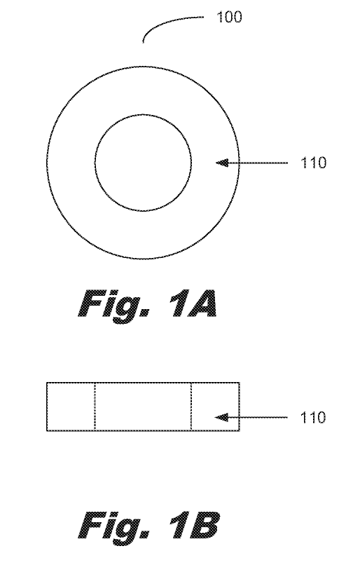

FIG. 1A shows a top view of a device (100) for treating teeth, the device comprising: an elastomeric ring (110), the elastomeric ring comprising: an elastomer and an ionic fluoride compound. FIG. 1B shows a cross sectional view of the elastomeric ring (110).

The shape of the elastomeric ring (110) may be suitable for treatment sites between two adjacent teeth. In this approach, the ring (110) surrounds the treatment site, providing the ionic fluoride compound to the treatment site. The ring (110) contains an ionic fluoride compound around the treatment site, allowing a higher local concentration compared to the concentration in the mouth generally. The higher local concentration may provide better treatment of the desired location while minimizing the amount of ionic fluoride compound that is swallowed and digested. The use of silver diamine fluoride may also be associated with blackening of the teeth. Keeping tooth blackening located to the surfaces between the teeth may provide a better cosmetic outcome for patients. Better cosmetic outcomes may be associated with higher rates of patient acceptance or higher rates of patient satisfaction with the outcome.

The elastomeric ring (110) may be a torus or a horn torus. The elastomeric ring may be a sectioned tube. The elastomeric ring (110) may be a tube with a rectangular or square cross section. In one example, the rings (110) are formed by slicing an extruded tube to form the desired shape.

The ring (110) may be formed of any material suitable for short term implantation under FDA guidelines. Further, new materials subject to appropriate tissue contact testing that meets the FDA approval process are also appropriate candidates. Silicone rubber provides one example material for an elastomer. Silicone rubber has a well-established history of biocompatibility. Other suitable elastomers include natural rubber and Acrylonitrile-Butadiene-Styrene (ABS) rubber. In one example, the elastomer is a silicone rubber is a block copolymer with silicone and carbohydrate blocks. The use of an elastomer may provide mechanical strength to the device and facilitates placement and removal.

In one example the ionic fluoride compound is an alkali metal ionic fluoride compound. For example, the ionic fluoride compound may be sodium fluoride (NaF), potassium fluoride (KF), and/or stannous fluoride (SnF₂). The ionic fluoride compound may be a mixture of ionic fluoride compounds. The ionic fluoride compound may include a fluoride salt.

The ionic fluoride compound may be a chelated metal ion salt. The metal ion may be a precious metal ion. Some precious metals have established biocompatibility profiles, e.g., gold, silver, and platinum group metals. Some precious metals have established antibacterial properties, e.g. silver, and copper. Silver salts may provide a desirable mixture of these two properties. In one example, the ionic fluoride compound is silver diamine fluoride. (SDF). SDF has been approved by FDA as a fluoride varnish to prevent dental carries. In another example, the silver may be provided as colloidal silver. The silver may be provided as a silver salt, e.g. silver chloride. The silver may be provided as a complement to a fluoride, e.g. a mixture of colloidal silver and sodium fluoride.

In one example, the elastomer includes additional saliva soluble species to facilitate or regulate dissolution of the ionic fluoride compound. The additional saliva soluble species may include salts, such as NaCl, or viscosity agents, such as polyethylene glycol (PEG) or starch. The elastomer may be loaded with bulk saliva soluble species that dissolve and reduce the volume of the implant. This dissolution can be used to facilitate or cause removal of the device (100). The additional saliva soluble species may encourage gel formation. In one example, the saliva soluble species include a group or moiety to interact with the elastomer. For example, a PEG chain may include a silicone tail.

The elastomeric ring (110) may be removed after placement. In one example, the elastomer ring (110) is removed after 21 days. The elastomer ring (110) may be removed between 14 and 28 days after placement. The elastomer ring (110) may be removed between 7 days and 28 days after placement.

In one example, the device (100) or a portion of the device (100) is resorbable. For example, the elastomer may be a block elastomer that includes blocks of both a rubber, for example, silicone rubber, and a degradable polymer. Salvia contains enzymes capable of breaking down carbohydrates, e.g., amylase. Accordingly, one potential block biodegradable polymer is starch. Starch also has the advantage of relatively low safety risk. Other biodegradable polymers such as poly lactic acid (PLA) and poly glycolic acid (PGA) can be formed into bock copolymers with rubbers, such as silicone rubbers.

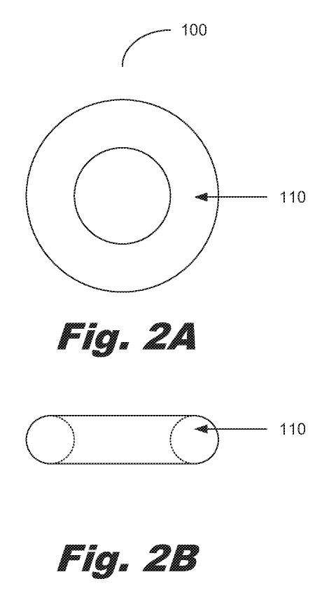

FIGS. 2A and 2B show a top view and a cross sectional view of a device according to the present disclosure. The device comprises a ring (110), where the ring includes an elastomer and an ionic fluoride compound.

In FIG. 2, the ring (110) is a torus with rounded edges as opposed to the rectangular cross section as seen in FIG. 1. The torus shape may be formed by molding, including injection molded.

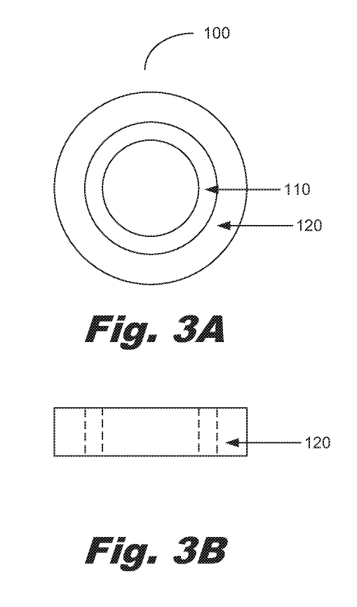

FIGS. 3A and 3B show a top view and a cross sectional view of a device (100) according to the present disclosure. The device (100) includes an elastomeric ring (110) that includes an ionic fluoride compound. The device (100) also includes a second elastomeric ring (120) that does not include an ionic fluoride compound.

In one example, the second elastomeric ring (120) is non-eluting. The second elastomeric ring (120) may elute other species than an ionic fluoride compound. In one example, the second elastomeric ring (120) may contain salt, an elution control agent, and/or a viscosity agent.

The use of silver diamine fluoride on teeth may be associated with blacking of the treated portion of the tooth/teeth. Accordingly, it may be desirable for cosmetic reasons to limit the SDF eluting portion to the area between the teeth or to the back of the teeth and not have the SDF eluting portion contacting the front of the teeth.

In one example, the device is used in primary teeth, i.e., deciduous or baby teeth. In another example, the device is used in secondary teeth, i.e., adult or permanent teeth. In some cases, the placement between primary and secondary teeth may be useful, especially between permanent first molars and primary second molars

The outer layer material may be an elasticized polymer that resists oral enzymes and not break down over time. The inner layer may be an elasticized polymer that could be saturated with SDF or other fluoride component that releases over time. The inner layer may be broken down with oral enzymes that would help in the release of fluoride into the inter-proximal tooth space.

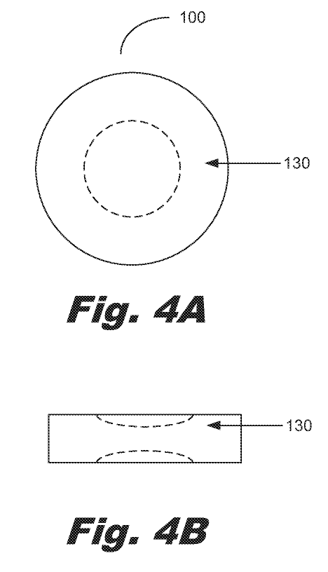

FIGS. 4A and 4B show a top view and a cross sectional view of a device according to the present disclosure. In FIG. 4, the device includes an elastomeric body (130) with a reduced area in the middle with a higher rim around the edge. There is no hole passing through the elastomeric body (130) of the device (100).

This design facilitates having two separate areas for the teeth on either side of the device (100). In one example, the device (100) elutes ionic fluoride compound from one side. The device (100) may elute the ionic fluoride compound from both sides. The device (100) may include a surface coating to regulate the release rate of the ionic fluoride compound or other components into the saliva. While FIGS. 4A and 4B show a square outer corner for the device (100), a rounded corner as shown in FIG. 2 can similarly be implemented.

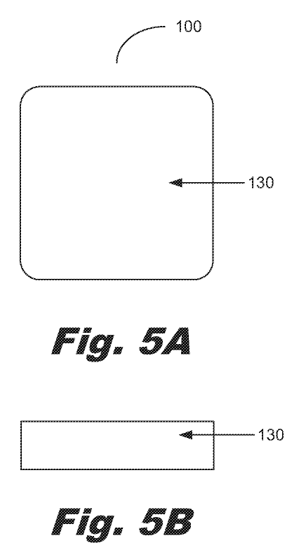

FIGS. 5A and 5B show a top view and a cross sectional view of a device according to the present disclosure. The device (100) includes an elastomeric body (130) that includes an ionic fluoride compound. The elastomeric body (130) of the device (100) is capable of being stretched to thin the elastomeric body (130); this facilitates sliding the elastomeric body (130) between a pair of teeth. The elastomeric body (130) is then released and the recoil of the elastomeric material helps the elastomeric body (130) to recover and press against the teeth. This recovery force helps to hold the elastomeric body (130) in place for the desired length of treatment, at which point the device (100) may be removed by grabbing a piece of the elastomeric body (130) and pulling.

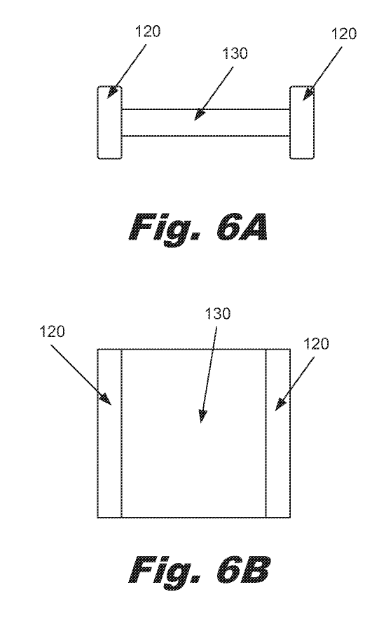

FIGS. 6A and 6B show a top view and a cross sectional view of a device (100) according to the present disclosure. The device has two portions. One portion is comprised of an elastomer body (130) that includes an ionic fluoride compound (110). The other portion is also an elastomeric body (130) but does not include an ionic fluoride compound (120). The device (100) is capable of being stretched to slip between two adjacent teeth. The device (100) is then allowed to recover and the central portion contacts the sides of the teeth between the teeth. This allows the ionic fluoride compound to be selectively applied to one surface of the teeth without applying the ionic fluoride compound to other surfaces of the teeth.

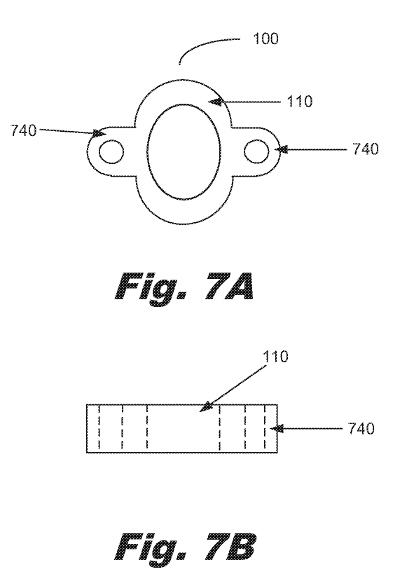

FIGS. 7A and 7B show a top view and a cross sectional view of a device (100) according to the present disclosure. The device (100) includes an elastomeric ring (110) including an ionic fluoride compound. The elastomeric ring (110) has a pair of tabs (740) located on opposite sides of the elastomeric ring (110). The tabs (740) aid in placing and/or removing the device (100) from between teeth. In one example, the tabs (740) are smaller loops with a lumen passing through the middle. Floss or a similar filament can be passed through the tabs (740). The floss can then be used to stretch the device (100).

In one example, the tabs (740) include nubs, groves, and/or indentations around which floss can be looped to grab and stretch the device (100). The tabs (740) may include a single opening each. The tabs (740) may include multiple openings. The tabs (740) may not have any openings. The tabs (740) may have the same composition as the elastomeric ring (110). The tabs (740) may have a lower loading of ionic fluoride compound than the elastomeric ring (110).

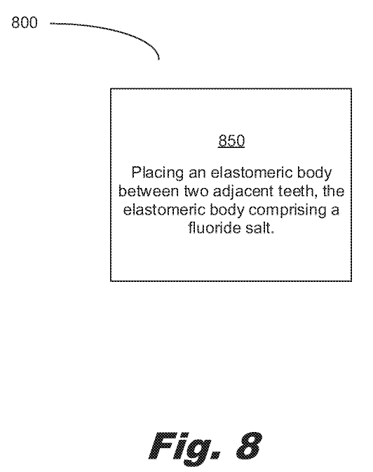

FIG. 8 shows a flowchart for a process (800) consistent with the present disclosure. The process includes placing (850) an elastomeric body between two adjacent teeth, the elastomeric body including an ionic fluoride compound.

In one example, placing (850) an elastomeric body (110) between two adjacent teeth, the elastomeric body (110) including an ionic fluoride compound includes the operation of stretching the elastomeric body (110) to reduce the width of the elastomeric body prior to placing the elastomeric body.

The method (800) may further comprise additional activities, such as: sliding the stretched elastomeric body between two teeth, and allowing the elastomeric body to recover against the two teeth and/or removing the elastomeric body after 14 days and prior to 28 days.

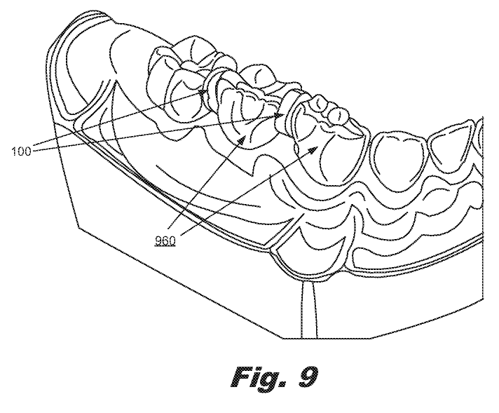

FIG. 9 shows a perspective drawing of two devices (100), each between two adjacent teeth (960) according to the present disclosure. The devices (100) are located between adjacent teeth (960). One device (100) includes a small channel that extends parallel to the jaw. The channel may aid in insertion and/or alignment of the device (100). The channel may accommodate floss or a tool during placement of the device (100). The channel may also reduce isolation of the volume in the ring of the device (100).

It will be appreciated that, within the principles described by this specification, a vast number of variations exist. It should also be appreciated that the examples described are just examples, and are not intended to limit the scope, applicability, or construction of the claims in any way.

What is claimed is:

1. A device for treating teeth, the device comprising an elastomeric ring, the elastomeric ring comprising:
an elastomer and
an ionic fluoride compound

2. The device of claim 1, wherein the elastomeric ring is a torus.

3. The device of claim 1, wherein the elastomeric has a rectangular cross section.

4. The device of claim 1, wherein the ionic fluoride compound is an alkaline fluoride.

5. The device of claim 4, wherein the ionic fluoride compound is sodium fluoride (NaF).

6. The device of claim 1, wherein elastomeric ring further comprises a precious metal.

7. The device of claim 6, wherein the ionic fluoride compound is silver diamine fluoride (SDF).

8. The device of claim 1, wherein the ionic fluoride compound has antibacterial properties.

9. The device of claim 1, wherein elastomeric ring further comprises a channel connecting an inside of the ring with an outside of the ring.

10. The device of claim 1, further comprising a second ring of elastomer encircling the elastomeric ring, wherein the second ring of elastomer is substantially free of fluoride.

11. The device of claim 10, wherein the elastomeric ring and the second elastomeric, ring are chemically bonded.

12. A device for treating teeth, the device comprising an elastomeric body, the elastomeric body comprising:
an elastomer and
an ionic fluoride compound.

13. The device of claim 12, wherein the elastomeric body further comprises a hole.

14. The device of claim 13, wherein the body sheet has a smaller thickness at a center of the elastomeric body than near a perimeter of the elastomeric body.

15. The device of claim 12, wherein the elastomer is a silicone rubber and the ionic fluoride compound is silver diamine fluoride.

16. A method of treating teeth, the method comprising placing an elastomeric body between two adjacent teeth, the elastomeric body comprising an ionic fluoride compound.

17. The method of claim 16, wherein placing the elastomeric body between two teeth further comprises stretching the elastomeric body, sliding the stretched elastomeric body between two teeth, and allowing the elastomeric body to recover against the two teeth.

18. The method of claim 16, further comprising: removing the elastomenc body after 14 days and prior to 28 days.

19. The method of claim 16, wherein the ionic fluoride compound is silver diamine fluoride (SDF).

20. The method of claim 16, wherein the ionic fluoride compound is sodium fluoride (NaF).
